(19) United States
(12) Patent Application Publication
(10) Pub. No.: US 2009/0172988 A1
(43) Pub. Date: Jul. 9, 2009

(54) INDICATION BRAND ASSEMBLY

(76) Inventors: Andy Kaoh, Taipei City (TW); Shieh-Hwei Lee Chen, Taipei City (TW)

Correspondence Address: Andy KAOH, 235 Chung - Ho, Box 8-24, Taipei, 235, TW

(21) Appl. No.: 11/969,228

(22) Filed: Jan. 4, 2008

(51) Int. Cl. G09F 7/18

(52) U.S. Cl. 40/611.11; 40/607.13

(57) ABSTRACT

An indication brand assembly comprises a first frame and a second frame; an indication brand having a first retaining frame and a second retaining frame at a backside thereof; the second retaining frame being formed with an embedding groove; an adaptor; an elastic unit enclosing and retaining to the adaptor; a supporting frame connected to the first retaining frame by using an adaptor; the supporting frame having an embedding groove for receiving one end of a first frame; wherein by the extension or compression of the elastic unit, the indication brand can be engaged with the first frame and the second frame easily The elastic unit is a spring so that the supporting frame can move upwards and downwards. The adaptor is a screw or a rivet for engaging with the elastic unit. The supporting frame and second retaining frame have respective embedding grooves.

### FIELD OF THE INVENTION

The present invention relates to indication brands, and particularly to an indication brand assembly, wherein an elastic unit is installed so as to achieve the object of fast assembly and detachment of the indication brand by extension and compression of the elastic unit.

### BACKGROUND OF THE INVENTION

Referring to FIG. 1, a prior art indication brand 100 is illustrated. The indication brand 100 has a retaining supporter 300 at a rear side thereof. The retaining supporter 300 retains the indication brand 100 to a frame 200 of a wall by using screws 400 so as to fix the indication brand 100. However in this prior art, the assembly and detachment of the indication brand are inconvenient and time consumed.

Thus the prior art indication brand is only suitable for the indication brand which is installed for a long time without needing to update, but for the indication brands needed to be updated frequently, such as an advertisement board, or a fee table, etc., this prior art way is not convenient. Furthermore, if the prior art indication brand is detached and assembled frequently, it will destroy easily.

However, the prior art has the defects that no elastic unit is used so that the indication brand is difficult in assembly and detaching. Furthermore, the frame has no embedding groove, it is difficult to be assembled. No adaptor is provided to the elastic unit. The user is difficult to install the indication brand so that it is not competitive commercially.

### SUMMARY OF THE INVENTION

Accordingly, the primary object of the present invention is to provide an indication brand assembly, wherein an elastic unit is installed so as to achieve the object of fast assembly and detachment of the indication brand by extension and compression of the elastic unit.

To achieve above objects, the present invention provides an indication brand assembly, comprising: a first frame and a second frame; an indication brand having a first retaining frame and a second retaining frame at a backside thereof; the second retaining frame being formed with an embedding groove; an adaptor; an elastic unit enclosing and retaining to the adaptor; a supporting frame connected to the first retaining frame by using an adaptor; the supporting frame having an embedding groove for receiving one end of a first frame; wherein by the extension or compression of the elastic unit, the indication brand can be engaged with the first frame and the second frame easily.

The elastic unit is a spring so that the supporting frame can move upwards and downwards. The adaptor is a screw or a rivet for engaging with the elastic unit. The supporting frame has an embedding groove for receiving the first frame. The second retaining frame has an embedding groove for receiving the second frame.

The various objects and advantages of the present invention will be more readily understood from the following detailed description when read in conjunction with the appended drawing.

### BRIEF DESCRIPTION OF THE DRAWINGS

FIG. 1 is a schematic view of a prior art indication brand.

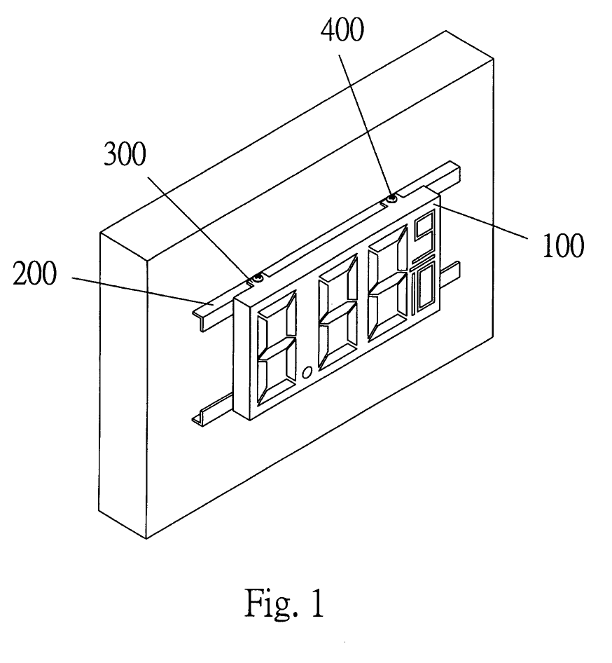

FIG. 2 is an exploded perspective view of the present invention.

FIG. 3 is a schematic view of the present invention.

FIG. 4 is a schematic view showing the installation of the indication brand of the present invention.

FIG. 5 is a schematic view about the installation of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

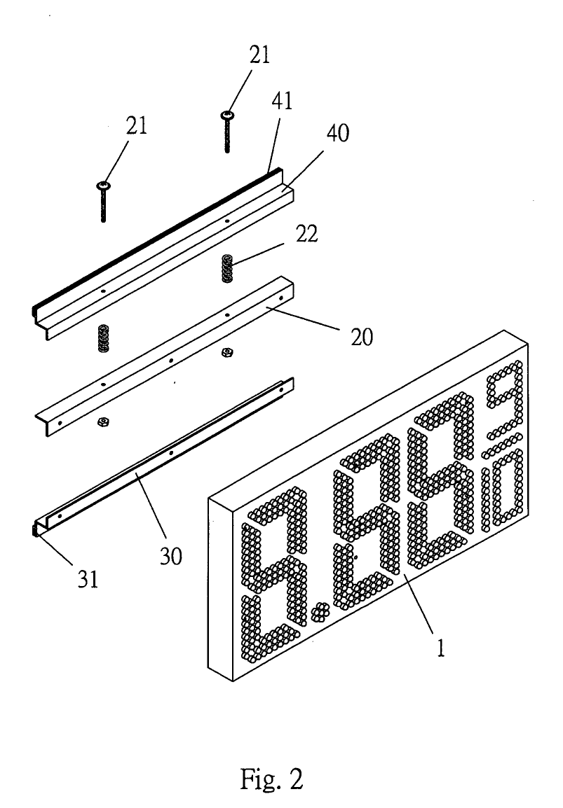

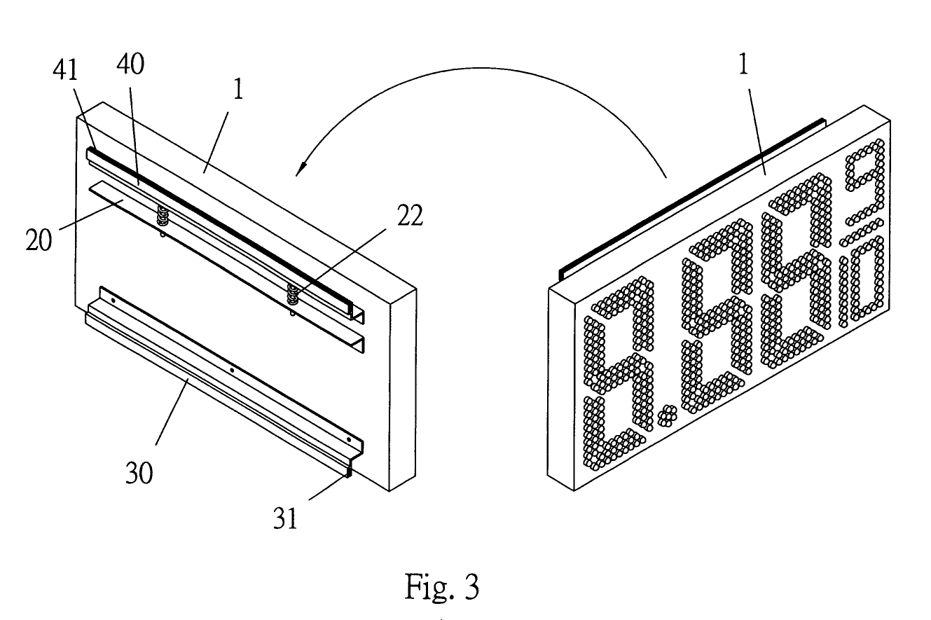

With referring to FIGS. 2 and 3, the structure of the present invention is illustrated. The present invention has the following elements.

The indication brand with a retaining assembly which can be retained and detached easily and inconveniently.

A first frame 10 and a second frame 11 are included.

An indication brand 1 has a first retaining frame 20 and a second retaining frame 30 at a backside thereof. The second retaining frame 30 is formed with an embedding groove 31.

An adaptor 21 is a screw or a rivet.

An elastic unit 22 encloses and thus retains to the adaptor 21.

A supporting frame 40 is connected to the first retaining frame 20 by using an adaptor 21. The supporting frame 40 has an embedding groove 41 for receiving one end of a first frame 10.

By the extension or compression of the elastic unit 22, the indication brand 1 can be engaged with the first frame 10 and the second frame 11 easily.

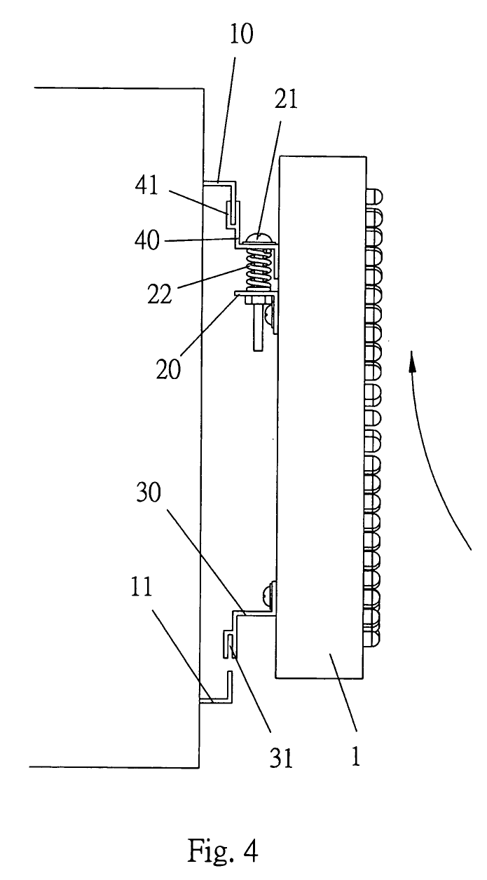

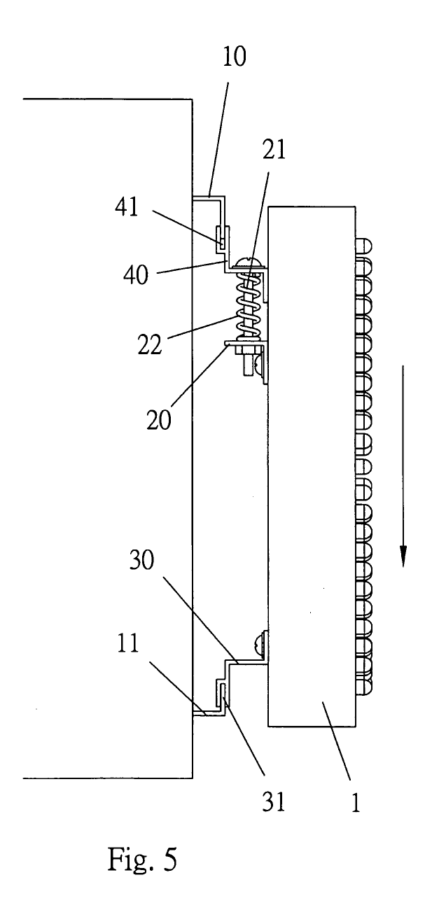

Referring to FIGS. 4 and 5, the installation of the present invention will be described herein. In assembly, the second retaining frame 30 is engaged to the second frame 11 and then the supporting frame 40 is compressed so as to compress the elastic unit 22. Then the supporting frame 40 aligns to the first frame 10 and then is released. By extension of the elastic unit 22, the supporting frame 40 is buckled to the first frame 10. Thus the indication brand 1 of the present invention can be installed rapidly. Another in assembly, it can be firstly to combine the supporting frame 40 to the first frame 10, and then the indication brand 1 will compress the supporting frame 40 to cause the elastic unit 22 to compress and thus moves. At the same time, the second retaining frame 30 will align the second frame 11 and then is released. By extension of the elastic unit 22 and movement of the elastic unit 22, the second retaining frame 30 is engaged to the second frame 11.

In detaching the indication brand 1, the supporting frame 40 is compressed upwards so that the second retaining frame 30 will separate from the second frame 11. At the time of pushing the indication brand 1 outwards, the second retaining frame 30 is separated from the second frame 11 so as to complete the work of detaching.

Advantages of the present invention will be described herein. The elastic unit of the present invention will cause the indication brand can be assembled and detached rapidly. Furthermore, the embedding groove of the second retaining frame will cause the first frame and the second frame to be firmly secured therein. The present invention has an adaptor for receiving the elastic unit so that the user can use the indication brand easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An indication brand assembly, comprising:
a first frame and a second frame;
an indication brand having a first retaining frame and a second retaining frame at a backside thereof; the second retaining frame being formed with an embedding groove;
an adaptor;
an elastic unit enclosing and retaining to the adaptor;
a supporting frame connected to the first retaining frame by using an adaptor; the supporting frame having an embedding groove for receiving one end of a first frame;
wherein by the extension or compression of the elastic unit, the indication brand can be engaged with the first frame and the second frame easily.

2. The indication brand assembly as claimed in claim 1, wherein the elastic unit is a spring so that the supporting frame can move upwards and downwards.

3. The indication brand assembly as claimed in claim 1, wherein the adaptor is a screw or a rivet for engaging with the elastic unit.

4. The indication brand assembly as claimed in claim 1, wherein the supporting frame has an embedding groove for receiving the first frame.

5. The indication brand assembly as claimed in claim 1, wherein the second retaining frame has an embedding groove for receiving the second frame.
